(19) United States
(12) Patent Application Publication
(10) Pub. No.: US 2024/0031006 A1
(43) Pub. Date: Jan. 25, 2024

(54) BEAM TRAINING FOR COORDINATED RELAYING

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Alexandros MANOLAKOS, Escondido, CA (US)

(21) Appl. No.: 18/255,032

(22) PCT Filed: Jan. 24, 2022
(86) PCT No.: PCT/US2022/070309

§ 371 Date: May 30, 2023

(30) Foreign Application Priority Data
Feb. 25, 2021 (GR) 20210100113

(51) Int. Cl. H04B 7/155; H04B 7/08; H04B 7/06

(52) U.S. Cl. CPC H04B 7/15592; H04B 7/088; H04B 7/0695

(57) ABSTRACT

Various aspects of the present disclosure generally relate to wireless communication. In some aspects, a receiving wireless communication device may receive, from a plurality of relay user equipment (UEs), a plurality of beamformed reference signals associated with a set of time resources for beam training for coordinated relaying. The UE may transmit an indication of a reference signal index that indicates a selected beam based at least in part on a determination that at least one measurement associated with the plurality of beamformed reference signals satisfies one or more measurement criteria. Numerous other aspects are described.

### CROSS-REFERENCE TO RELATED APPLICATION

This Patent application claims priority to Greece Provisional Patent Application No. 20210100113, filed on Feb. 25, 2021, entitled “BEAM TRAINING FOR COORDINATED RELAYING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for beam training for coordinated relaying.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a receiving user equipment (UE) for wireless communication includes a memory; and one or more processors, coupled to the memory, configured to: receive, from a plurality of relay UEs, a plurality of beamformed reference signals associated with a set of time resources for beam training for coordinated relaying; and transmit an indication of a reference signal index that indicates a selected beam based at least in part on a determination that at least one measurement associated with the plurality of beamformed reference signals satisfies one or more measurement criteria.

In some aspects, a relay UE for wireless communication includes a memory; and one or more processors, coupled to the memory, configured to: transmit, to a receiving UE, a beamformed reference signal of a plurality of beamformed reference signals associated with a set of time resources; and receive an indication of a reference signal index that indicates a selected beam based at least in part on a determination that at least one measurement associated with the plurality of beamformed reference signals satisfies one or more measurement criteria.

In some aspects, a method of wireless communication performed by a receiving UE includes receiving, from a plurality of relay UEs, a plurality of beamformed reference signals associated with a set of time resources for beam training for coordinated relaying; and transmitting an indication of a reference signal index that indicates a selected beam based at least in part on a determination that at least one measurement associated with the plurality of beamformed reference signals satisfies one or more measurement criteria.

In some aspects, a method of wireless communication performed by a relay UE includes transmitting, to a receiving UE, a beamformed reference signal of a plurality of beamformed reference signals associated with a set of time resources; and receiving an indication of a reference signal index that indicates a selected beam based at least in part on a determination that at least one measurement associated with the plurality of beamformed reference signals satisfies one or more measurement criteria.

In some aspects, a non-transitory computer-readable medium storing a set of instructions for wireless communication includes one or more instructions that, when executed by one or more processors of a receiving UE, cause the receiving wireless communication device to: receive, from a plurality of relay UEs, a plurality of beamformed reference signals associated with a set of time resources for beam training for coordinated relaying; and transmit an indication of a reference signal index that indicates a selected beam based at least in part on a determination that at least one measurement associated with the plurality of beamformed reference signals satisfies one or more measurement criteria.

In some aspects, a non-transitory computer-readable medium storing a set of instructions for wireless communication includes one or more instructions that, when executed by one or more processors of a relay UE, cause the relay UE to: transmit, to a receiving UE, a beamformed reference signal of a plurality of beamformed reference signals associated with a set of time resources; and receive an indication of a reference signal index that indicates a selected beam based at least in part on a determination that at least one measurement associated with the plurality of beamformed reference signals satisfies one or more measurement criteria.

In some aspects, an apparatus for wireless communication includes means for receiving, from a plurality of relay UEs, a plurality of beamformed reference signals associated with a set of time resources for beam training for coordinated relaying; and means for transmitting an indication of a reference signal index that indicates a selected beam based at least in part on a determination that at least one measurement associated with the plurality of beamformed reference signals satisfies one or more measurement criteria.

In some aspects, an apparatus for wireless communication includes means for transmitting, to a receiving UE, a beamformed reference signal of a plurality of beamformed reference signals associated with a set of time resources; and means for receiving an indication of a reference signal index that indicates a selected beam based at least in part on a determination that at least one measurement associated with the plurality of beamformed reference signals satisfies one or more measurement criteria.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of coordinated relaying, in accordance with the present disclosure.

FIGS. 6 and 7 are diagrams illustrating examples associated with beam training for coordinated relaying, in accordance with the present disclosure.

FIGS. 8 and 9 are diagrams illustrating example processes associated with beam training for coordinated relaying, in accordance with the present disclosure.

FIGS. 10 and 11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

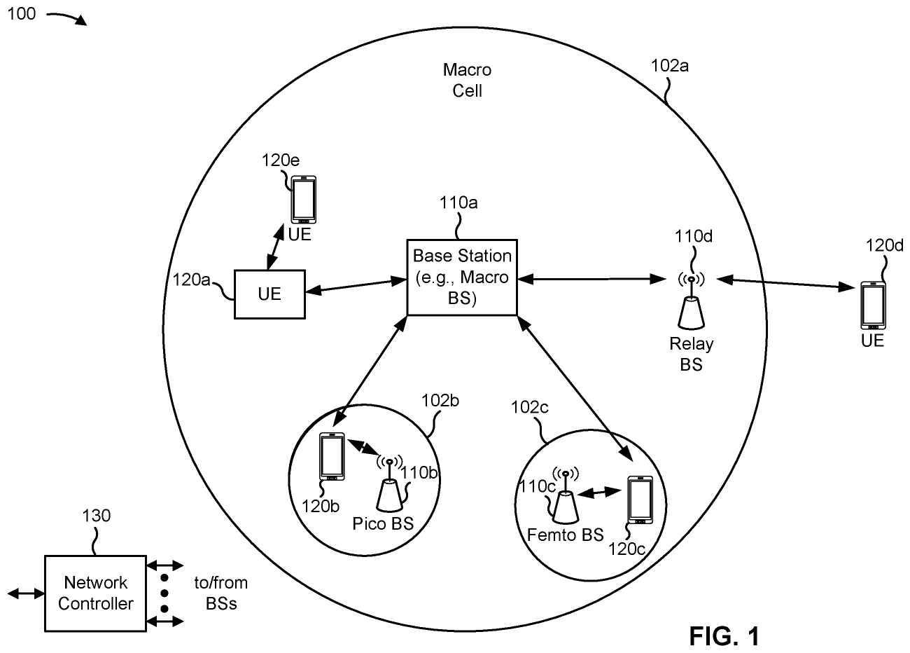

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”), a BS (referred to herein, interchangeably, as a “non-terrestrial BS” and “non-terrestrial base station”), and/or a relay station (referred to herein, interchangeably, as a “non-terrestrial relay station”), among other examples. As used herein, an NTN may refer to a network for which access is facilitated by a non-terrestrial UE, non-terrestrial BS, and/or a non-terrestrial relay station, among other examples.

The wireless network 100 may include any number of non-terrestrial wireless communication devices. A non-terrestrial wireless communication device may include a satellite, a manned aircraft system, and/or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, helicopter, and/or a dirigible, among other examples. A UAS platform may include a high-altitude platform station (HAPS), and may include a balloon, a dirigible, and/or an airplane, among other examples. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of BSs (e.g., stationary and/or ground-based BSs), relay stations, and/or one or more components and/or devices included in a core network of wireless network 100, among other examples.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul. For example, in some aspects, the wireless network 100 may be, include, or be included in a wireless backhaul network, sometimes referred to as an integrated access and backhaul (IAB) network. In an IAB network, at least one base station (e.g., base station 110) may be an anchor base station that communicates with a core network via a wired backhaul link, such as a fiber connection. An anchor base station may also be referred to as an IAB donor (or IAB-donor), a central entity, and/or a central unit, among other examples. An IAB network may include one or more non-anchor base stations, sometimes referred to as relay base stations or IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 120) via access links, which may be wireless links for carrying access traffic.

In some aspects, a radio access network that includes an IAB network may utilize millimeter wave technology and/or directional communications (e.g., beamforming and/or precoding, among other examples) for communications between base stations and/or UEs (e.g., between two base stations, between two UEs, and/or between a base station and a UE). For example, wireless backhaul links between base stations may use millimeter waves to carry information and/or may be directed toward a target base station using beamforming, and/or precoding, among other examples. Similarly, wireless access links between a UE and a base station may use millimeter waves and/or may be directed toward a target wireless node (e.g., a UE and/or a base station). In this way, inter-link interference may be reduced.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

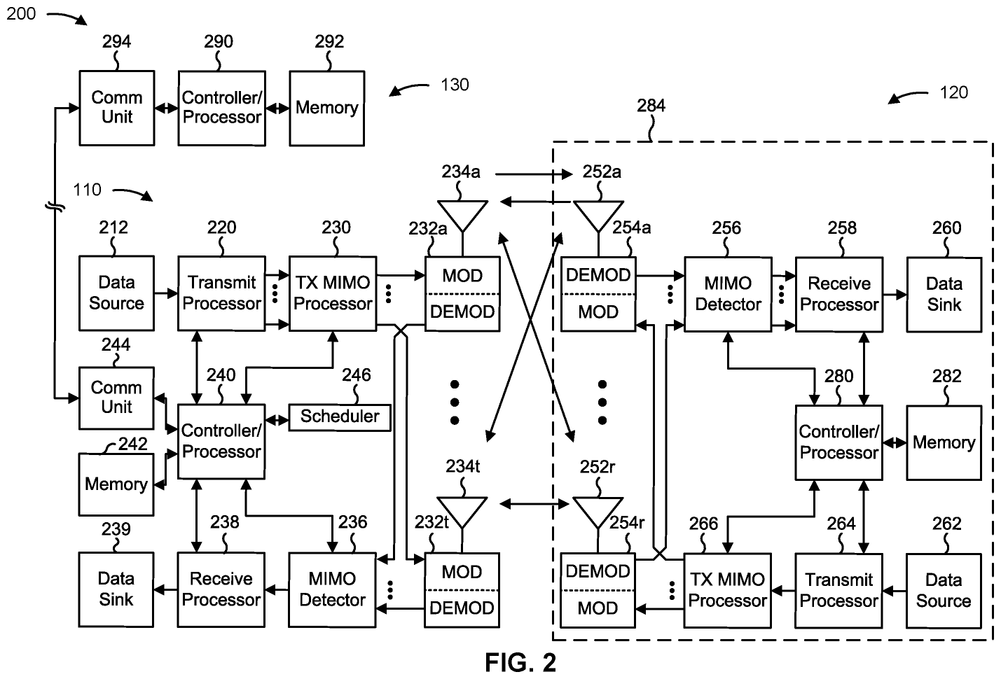

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

In 5G and other types of RATs, beamforming may be used for communications between a UE and a base station, such as for millimeter wave communications, among other examples. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication is an indication of a beam. A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, and/or qcl-TypeD, among other examples), a cell identification (e.g., a ServCellIndex), a bandwidth part identification (bwp-Id), and/or a reference signal identification such as a CSI-RS (e.g., an NZP-CSI-RS-Resourceld and/or an SSB Index, among other examples), among other examples. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, the network may support common TCI state ID update and activation to provide common QCL information and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide a QCL Type-D indication and to determine UL transmission spatial filters across the set of configured CCs.

Some UEs and/or base stations may support full duplex operation in which the UEs and/or the base stations support full duplex operations. For example, a UE may support transmission via a first beam (e.g., using a first antenna panel) and may simultaneously support reception via a second beam (e.g., using a second antenna panel). Support for simultaneous transmission and reception may be conditional on beam separation, such as spatial separation (e.g., using different beams), and/or frequency separation, among other examples. Additionally, or alternatively, support for simultaneous transmission may be conditional on using beamforming.

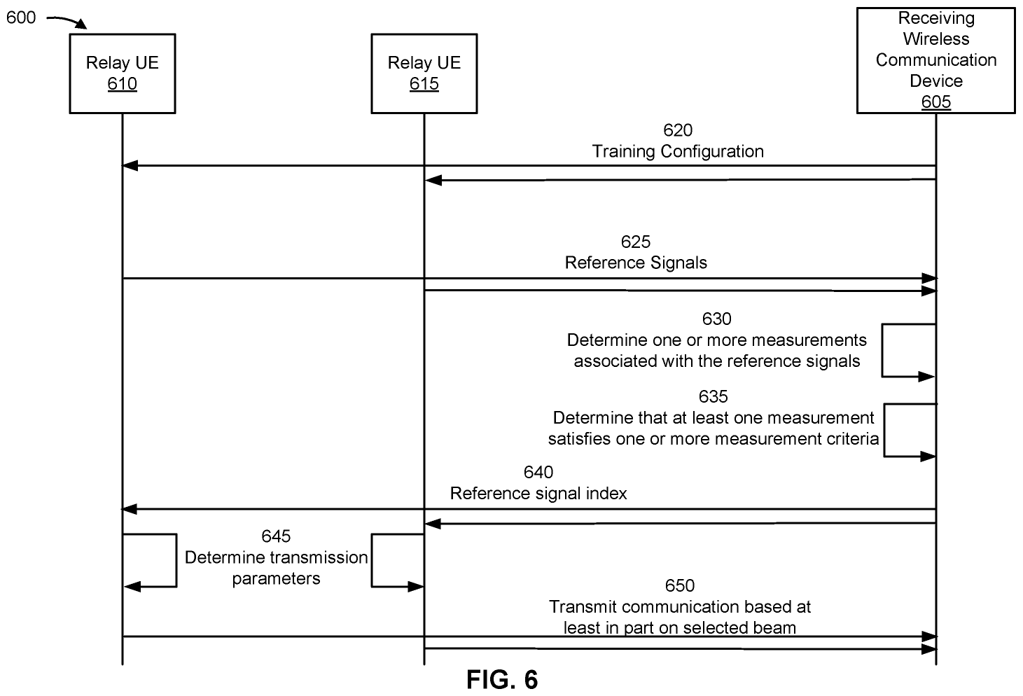

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 6-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 6-11).

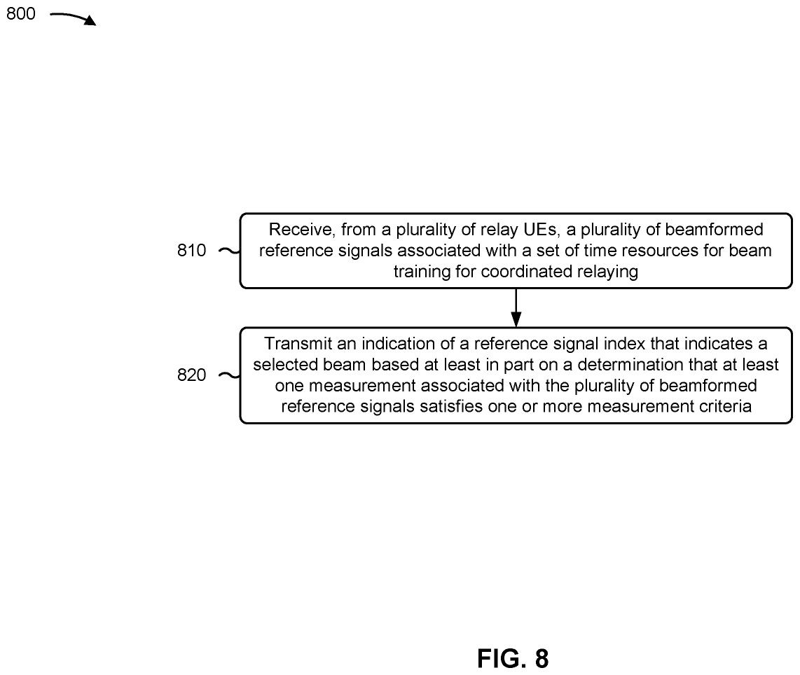

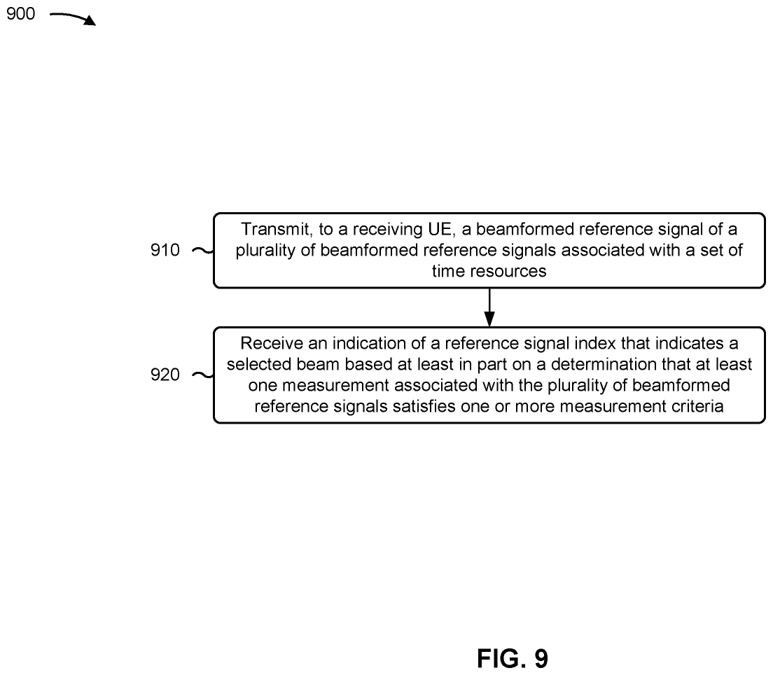

Controller/processor 240 of base station 110, controller/processor 280 of UE 120, and/or any other component(s) of FIG. 2 may perform one or more techniques associated with beam training for coordinated relaying, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, the receiving wireless communication device includes means for receiving, from a plurality of relay UEs, a plurality of beamformed reference signals associated with a set of time resources for beam training for coordinated relaying; or means for transmitting an indication of a reference signal index that indicates a selected beam based at least in part on a determination that at least one measurement associated with the plurality of beamformed reference signals satisfies one or more measurement criteria. The means for the receiving wireless communication device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the receiving wireless communication device includes means for determining that at least one measurement associated with the plurality of beamformed reference signals satisfies one or more measurement criteria. In some aspects, the receiving wireless communication device includes means for receiving a plurality of instances of a communication from the plurality of relay UEs based at least in part on the reference signal index. In some aspects, the receiving wireless communication device includes means for transmitting a training configuration to the plurality of relay UEs, wherein the training configuration indicates a quantity of time resources in the set of time resources. In some aspects, the receiving wireless communication device includes means for selecting the selected beam based at least in part on a beam training procedure having at least one phase, wherein the at least one phase comprises at least one of a beam down-selection procedure or a UE down-selection procedure.

In some aspects, the receiving wireless communication device includes means for performing the beam down-selection procedure based at least in part on facilitating a selection of a subset of beams of a set of beams, wherein the subset of beams includes the selected beam. In some aspects, the receiving wireless communication device includes means for performing the UE down-selection procedure based at least in part on selecting the plurality of UEs from among a larger plurality of UEs based at least in part on one or more performance measurements associated with the larger plurality of UEs.

In some aspects, the receiving wireless communication device includes means for transmitting a beam training procedure configuration that indicates the at least one phase. In some aspects, the receiving wireless communication device includes means for transmitting an activation indication associated with the beam training procedure via at least one of: a radio resource control (RRC) message, a medium access control control element (MAC CE), a DCI transmission, or a sidelink control information (SCI) transmission. In some aspects, the receiving wireless communication device includes means for transmitting a gap timing that indicates an amount of time between a first event and a second event, wherein the first event comprises at least one of an activation or a first training phase, and wherein the second event comprises a second training phase. In some aspects, the receiving wireless communication device includes means for determining the at least one measurement associated with the plurality of beamformed reference signals.

In some aspects, the relay UE includes means for transmitting, to a receiving UE, a beamformed reference signal of a plurality of beamformed reference signals associated with a set of time resources; or means for receiving an indication of a reference signal index that indicates a selected beam based at least in part on a determination that at least one measurement associated with the plurality of beamformed reference signals satisfies one or more measurement criteria. The means for the relay UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the relay UE includes means for transmitting an instance of a communication of a plurality of instances of the communication to the receiving UE based at least in part on the reference signal index. In some aspects, the relay UE includes means for encoding the instance of the communication based at least in part on one or more precoders associated with the reference signal index. In some aspects, the relay UE includes means for receiving a training configuration from the receiving UE, wherein the training configuration indicates a quantity of time resources in the set of time resources. In some aspects, the relay UE includes means for receiving an indication of a result of a beam down-selection procedure based at least in part on a selection of a subset of beams of a set of beams, wherein the subset of beams includes the selected beam.

In some aspects, the relay UE includes means for receiving a beam training procedure configuration that indicates the at least one phase. In some aspects, the relay UE includes means for receiving an activation indication associated with the beam training procedure via at least one of an RRC message, a MAC CE, a DCI transmission, or an SCI transmission. In some aspects, the relay UE includes means for receiving a gap timing that indicates an amount of time between a first event and a second event, wherein the first event comprises at least one of an activation or a first training phase, and wherein the second event comprises a second training phase.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

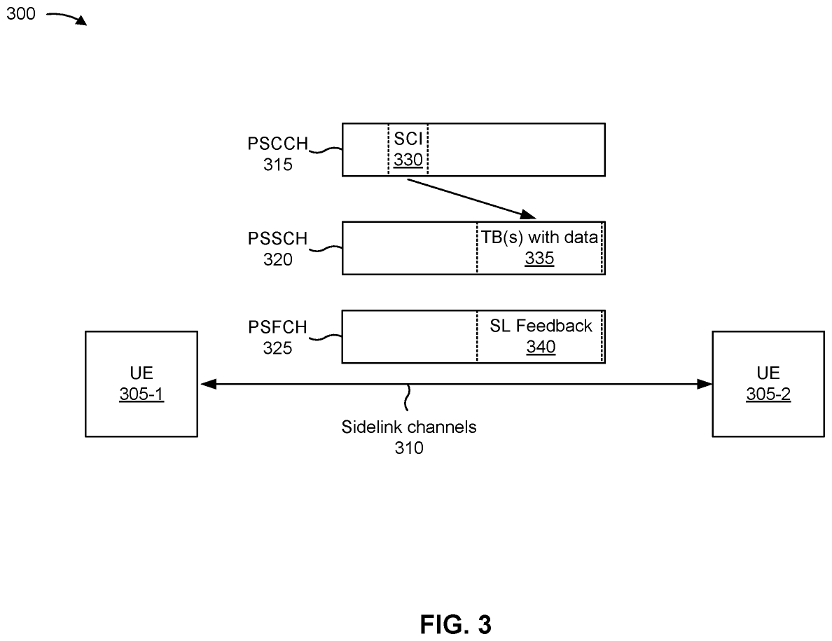

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or vehicle to pedestrian (V2P) communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a PDSCH and/or a physical uplink shared channel (PUSCH) used for cellular communications with a base station 110 via an access link or an access channel. For example, the PSCCH 315 may carry SCI 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., ACK/NACK information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in DCI or in an RRC message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

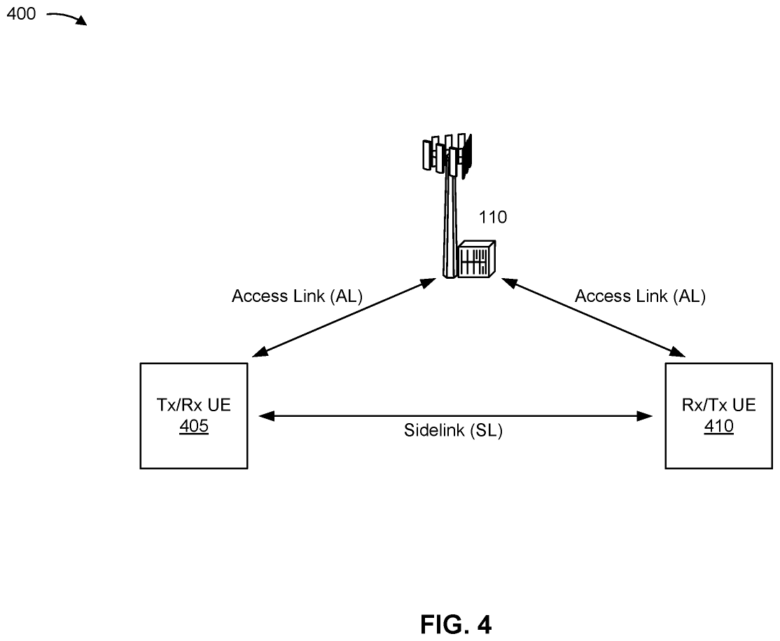

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

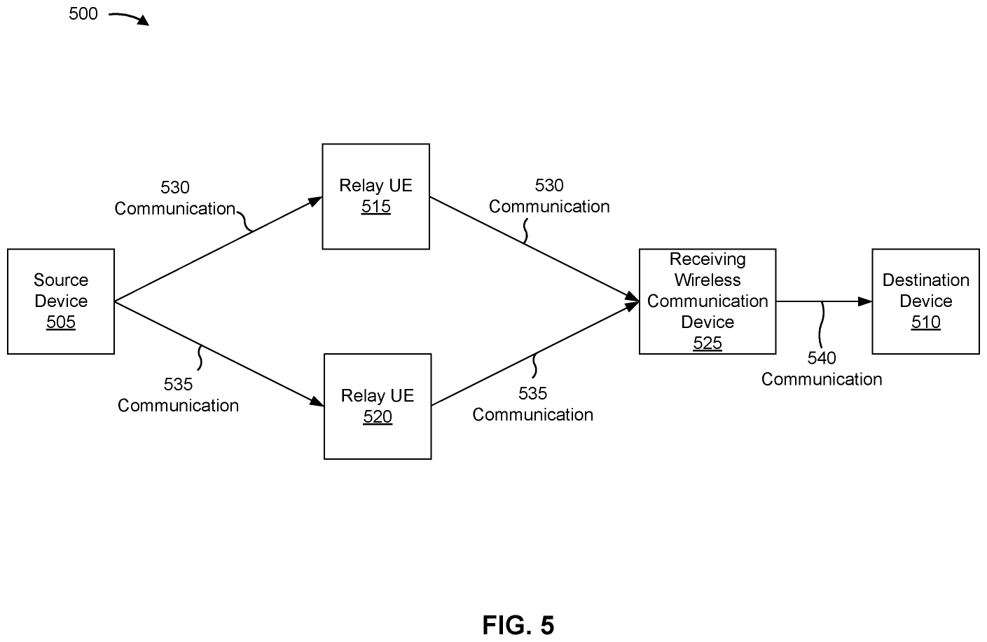

FIG. 5 is a diagram illustrating an example 500 of coordinated relaying, in accordance with the present disclosure. As shown, example 500 includes a source device 505, a destination device 510, a relay UE 515, a relay UE 520, and a receiving wireless communication device 525. In some aspects, the source device 505 may be a UE, a CPE, a wearable device (e.g., a smartwatch, a sensor device, or a health monitor, among other examples), and/or a base station, among other examples. The destination device 510 and/or the receiving wireless communication device 525 may be a UE, a repeater, a relay device, and/or a base station, among other examples. In some aspects, any number of other relay UEs and/or receiving wireless communication devices may be implemented.

As shown, the source device 505 may transmit a communication (e.g., a control communication and/or a data communication) 530 to the relay UE 515. The communication 530 may be addressed to the destination device 510. The source device 505 may transmit a communication 535 to the relay UE 520. The communication 535 may be a copy of the communication 530, or a portion thereof. In some aspects, the communication 530 may be a first portion of a total communication and the communication 535 may be a second portion of the total communication. In this way, the two portions 530 and 535 of the total communication may be assembled by the destination device 510, after being received by the destination device 510, to recreate the total communication.

As shown, the relay UE 515 may transmit the communication 530 to the receiving wireless communication device 525, and the relay UE 520 may transmit the communication 535 to the receiving wireless communication device 525. The receiving wireless communication device 525 may transmit a communication 540 to the destination device 510 (or another relay device, not shown). The communication 540 may be, or include, the communication 530, the communication 535, and/or an aggregation thereof.

In some cases, the relay UE 515 and the relay UE 520 may transmit the communications 530 and 535 simultaneously, or approximately simultaneously. If the relay UE 515 uses a first beam and the relay UE 520 uses a second beam that has a relatively different direction and/or signal power, among other example beam characteristics, the receiving wireless communication device 525 may fail to receive one of the communications 530 or 535, which may have a negative effect on network performance. Although the receiving wireless communication device 525 may be equipped with a capability of receiving multiple communications using disparate beams, doing so may unnecessarily decrease efficiency and increase signaling and/or processing overhead.

Some aspects of the subject matter disclosed herein may provide beam training for coordinated relaying. For example, in some aspects, a receiving wireless communication device may receive reference signals from each of a plurality of relay UEs and may select beams based at least in part on one or more measurements associated with the received reference signals. The receiving wireless communication device may transmit an indication to each of the relay UEs that indicates one or more beams and/or beam parameters for the relay UEs to use to transmit their respective relayed communications to the receiving wireless communication device.

In some aspects, the receiving wireless communication device may down-select a subset of relay UEs from a set of relay UEs based at least in part on one or more measurements associated with the reference signals. In some aspects, the receiving wireless communication device may down-select a subset of beams from a set of beams based at least in part on one or more measurements associated with the reference signals. In this way, some aspects of the subject matter disclosed herein may facilitate coordinated beamforming by relay UEs, thereby increasing the likelihood that the receiving wireless communication device receives relayed communications without unnecessarily increasing processing and/or signaling overhead. As a result, some aspects may have a positive effect on network performance.

As indicated above, FIG. 5 is provided as an example. Other examples may differ from what is described with respect to FIG. 5.

FIG. 6 is a diagram illustrating an example 600 associated with beam training for coordinated relaying, in accordance with the present disclosure. As shown in FIG. 6, a receiving wireless communication device 605 may communicate with a relay UE 610 and a relay UE 615. In some aspects, the receiving wireless communication device 605 may be similar to the receiving wireless communication device 525 shown in FIG. 5. In some aspects, the relay UE 610 and/or the relay UE 615 may be similar to the relay UE 515 and/or the relay UE 520 shown in FIG. 5. In some aspects, the example 600 may include any number of additional relay UEs, receiving wireless communication devices, a source device, and/or a destination device.

As shown by reference number 620, the receiving wireless communication device 605 may transmit, and the relay UE 610 and relay UE 615 may receive, a training configuration. The training configuration may indicate a reference signal configuration, a resource allocation, and/or one or more beam parameters, among other examples. The training configuration may indicate a quantity of time resources to be used by the relay UE 610 and relay UE 615 for transmitting reference signals to the receiving wireless communication device 605. The receiving wireless communication device 605 may transmit the training configuration using an RRC message, a MAC CE, a DCI transmission, and/or an SCI transmission, among other examples.

As shown by reference number 625, the relay UE 610 and the relay UE 615 may transmit, and the receiving wireless communication device 605 may receive, a plurality of beamformed reference signals. In some aspects, the beamformed reference signals may be associated with a set of time resources for beam training for coordinated relaying. In some aspects, the beamformed reference signals may be transmitted via a sidelink connection and/or an access link connection. The reference signals may be beamformed using analog beamforming and/or digital beamforming. In some aspects, the receiving wireless communication device 605 may transmit, and the relay UEs 610 and 615 may receive, an activation indication associated with a beam training procedure. The activation indication may be transmitted via an RRC message, a MAC CE, a DCI transmission, and/or an SCI transmission.

As shown by reference number 630, the receiving wireless communication device 605 may determine one or more measurements associated with the reference signals. For example, the one or more measurements may include a standard parasitic exchange format (SPEF) measurement associated with a beamformed reference signal of the plurality of beamformed reference signals, an energy measurement associated with the beamformed reference signal of the plurality of beamformed reference signals, and/or a signal to interference plus noise ratio (SINR) associated with the beamformed reference signal of the plurality of beamformed reference signals. In some aspects, the receiving wireless communication device 605 may determine one or more measurements associated with each reference signal of the plurality of reference signals.

As shown by reference number 635, the receiving wireless communication device 605 may determine that at least one measurement associated with the plurality of beamformed reference signals satisfies one or more measurement criteria. In this way, the receiving wireless communication device 605 may select a beam and/or determine one or more beam characteristics corresponding to a best performance.

In some aspects, the receiving wireless communication device 605 may perform a beam training procedure that has one or more phases. For example, in some aspects, the training configuration transmitted by the receiving wireless communication device 605 may indicate the one or more phases. Each of the one or more phases may include a beam down-selection procedure and/or a UE down-selection procedure. For example, in a first phase, the receiving wireless communication device 605 may receive a first set of reference signals from the relay UEs 610 and 615, and in a second phase, the receiving wireless communication device 605 may receive a second set of reference signals from the relay UEs 610 and 615.

In some aspects, the receiving wireless communication device 605 may transmit a gap timing that indicates an amount of time between a first event and a second event. The gap timing may be used to synchronize transmission of the reference signals to support one or more training phases. For example, the first event may include at least one of an activation or a first training phase, and the second event may include a first training phase or a second training phase.

In some aspects, the receiving wireless communication device 605 may perform a UE down-selection procedure based at least in part on selecting a plurality of relay UEs from among a larger plurality of relay UEs. The receiving wireless communication device 605 may select the plurality of relay UEs, for example, based at least in part on one or more performance measurements associated with the larger plurality of UEs. The one or more performance measurements may include the one or more measurements associated with the reference signals described above.

As shown by reference number 640, the receiving wireless communication device 605 may transmit, and the relay UEs 610 and 615 may receive, an indication of a reference signal index. In some aspects, the reference signal index may indicate a selected beam and/or one or more selected beam characteristics. In some aspects, the receiving wireless communication device 605 may transmit the reference signal index based at least in part on the determination that at least one measurement associated with the plurality of beamformed reference signals satisfies one or more measurement criteria. The reference signal index may indicate the beam and/or beam characteristics explicitly or implicitly. For example, in some aspects, the reference signal index may include at least one of: a reference signal identifier corresponding to a set of reference signal resources, or a time index corresponding to a time resource of the set of time resources.

As shown by reference number 645, the relay UEs 610 and 615 may determine transmission parameters based at least in part on the reference signal index. For example, the transmission parameters may include a selection of a beam, one or more beam characteristics (e.g., beamwidth, beam power, beam direction), a selection of a precoder, and/or a selection of a beamforming parameter, among other examples. As shown by reference number 650, the relay UEs 610 and 615 may transmit respective communications based at least in part on the respective transmission parameters.

In some aspects, the transmission parameters associated with the relay UE 610 may be different than the transmission parameters associated with the relay UE 615. The respective transmission parameters of the relay UE 610 and the relay UE 615 may be selected to facilitate reception, by the receiving wireless communication device 605, of communications simultaneously, or at least approximately simultaneously, using a same or similar beam and/or a same or similar set of beam characteristics. In some aspects, the transmission parameters may be the same for the relay UE 610 and the relay UE 615. For example, in some aspects, the relay UE 610 and the relay UE 615 may encode the respective instances of the communication based at least in part on one or more precoders associated with the reference signal index.

As indicated above, FIG. 6 is provided as an example. Other examples may differ from what is described with respect to FIG. 6.

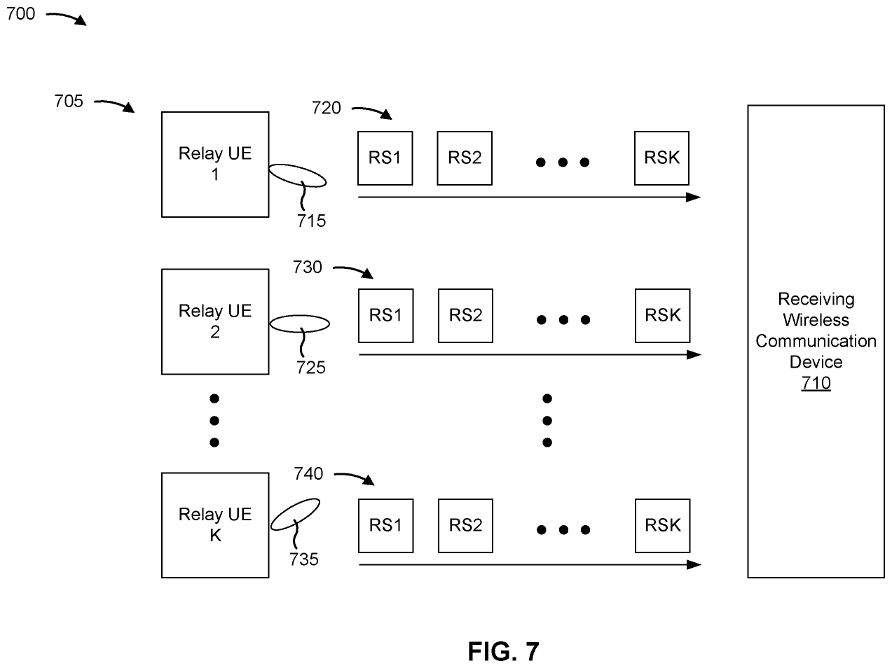

FIG. 7 is a diagram illustrating an example 700 associated with beam training for coordinated relaying, in accordance with the present disclosure. As shown in FIG. 7, a set 705 of relay UEs (shown as relay UE 1, relay UE 2, . . . , relay UE K) may communicate with a receiving wireless communication device 710. In some aspects, the receiving wireless communication device 710 may be, or be similar to, the receiving wireless communication device 605 shown in FIG. 6. In some aspects, the relay UEs of the set 705 of relay UEs may be, or be similar to, the relay UE 610 and/or the relay UE 615 shown in FIG. 6. In some aspects, the example 700 may include any number of additional relay UEs, receiving wireless communication devices, source devices, and/or destination devices.

Example 700 depicts an example of a resource allocation for a phase of a training procedure such as the training procedures discussed above in connection with FIG. 6. As shown, for example, the relay UE 1 may be configured to transmit, using a first beam 715, a chain 720 of reference signals (indicated as RS1, RS2, . . . , RSK). For example, the chain of reference signals may include a quantity of different reference signals equal to a quantity of relay UEs in the set 705 of relay UEs. Similarly, the relay UE 2 may be configured to transmit, using a second beam 725, a chain 730 of the same reference signals (indicated as RS1, RS2, . . . , RSK), and the relay UE K may be configured to transmit, using a Kth beam 735, a chain 740 of the same reference signals (indicated as RS1, RS2, . . . , RSK).

As shown, each reference signal may be transmitted during a separate time resource (each illustrated box indicates an allocated time resource). In this way, the receiving wireless communication device 710 may determine one or more measurements associated with each reference signal, for each beam, during each time resource. The receiving wireless communication device 710 may select a time resource and/or reference signal associated with a measurement that satisfies one or more measurement criteria and indicate one or more selected transmission parameters implicitly by transmitting an index that indicates a time resource and/or a reference signal.

As indicated above, FIG. 7 is provided as an example. Other examples may differ from what is described with respect to FIG. 7.

FIG. 8 is a diagram illustrating an example process 800 performed, for example, by a receiving wireless communication device, in accordance with the present disclosure. Example process 800 is an example where the receiving wireless communication device (e.g., receiving wireless communication device 605 or 710) performs operations associated with beam training for coordinated relaying.

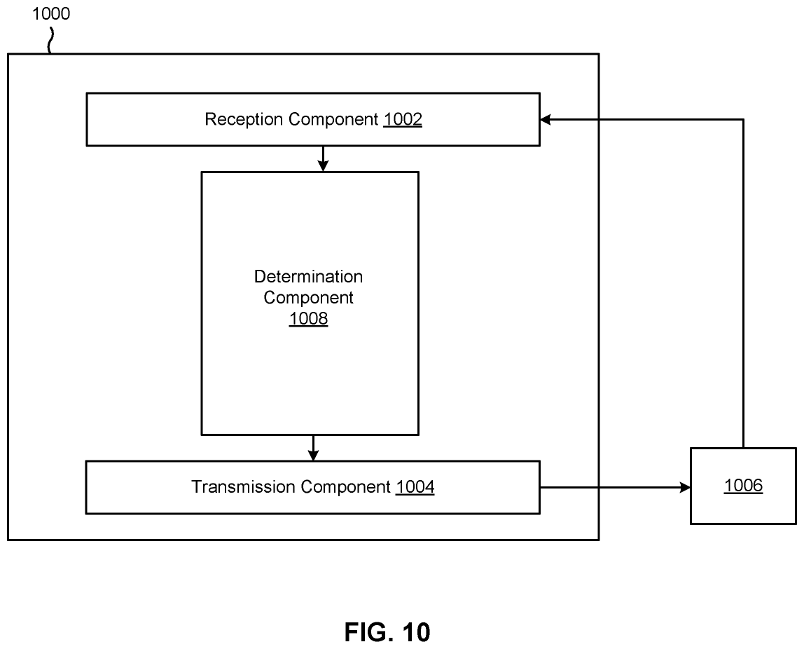

As shown in FIG. 8, in some aspects, process 800 may include receiving, from a plurality of relay UEs, a plurality of beamformed reference signals associated with a set of time resources for beam training for coordinated relaying (block 810). For example, the receiving wireless communication device (e.g., using reception component 1002, depicted in FIG. 10) may receive, from a plurality of relay UEs, a plurality of beamformed reference signals associated with a set of time resources for beam training for coordinated relaying, as described above.

As further shown in FIG. 8, in some aspects, process 800 may include transmitting an indication of a reference signal index that indicates a selected beam based at least in part on a determination that at least one measurement associated with the plurality of beamformed reference signals satisfies one or more measurement criteria (block 820). For example, the receiving wireless communication device (e.g., using transmission component 1004, depicted in FIG. 10) may transmit an indication of a reference signal index that indicates a selected beam based at least in part on a determination that at least one measurement associated with the plurality of beamformed reference signals satisfies one or more measurement criteria, as described above.

Process 800 may include additional aspects, such as any single aspect or any combination of aspects described below and/or in connection with one or more other processes described elsewhere herein.

In a first aspect, the at least one measurement comprises at least one of a standard parasitic exchange format measurement associated with a beamformed reference signal of the plurality of beamformed reference signals, an energy measurement associated with the beamformed reference signal of the plurality of beamformed reference signals, or a signal to interference plus noise ratio associated with the beamformed reference signal of the plurality of beamformed reference signals.

In a second aspect, alone or in combination with the first aspect, process 800 includes determining that at least one measurement associated with the plurality of beamformed reference signals satisfies one or more measurement criteria.

In a third aspect, alone or in combination with one or more of the first and second aspects, the reference signal index comprises at least one of a reference signal identifier corresponding to a set of reference signal resources, or a time index corresponding to a time resource of the set of time resources.

In a fourth aspect, alone or in combination with one or more of the first through third aspects, process 800 includes receiving a plurality of instances of a communication from the plurality of relay UEs based at least in part on the reference signal index.

In a fifth aspect, alone or in combination with the fourth aspect, the plurality of instances of the communication are encoded based at least in part on one or more precoders associated with the reference signal index.

In a sixth aspect, alone or in combination with one or more of the first through fifth aspects, process 800 includes transmitting a training configuration to the plurality of relay UEs, wherein the training configuration indicates a quantity of time resources in the set of time resources.

In a seventh aspect, alone or in combination with the sixth aspect, transmitting the training configuration comprises transmitting an RRC message, a MAC CE, a DCI transmission, or an SCI transmission.

In an eighth aspect, alone or in combination with one or more of the first through seventh aspects, process 800 includes selecting the selected beam based at least in part on a beam training procedure having at least one phase, wherein the at least one phase comprises at least one of a beam down-selection procedure or a UE down-selection procedure.

In a ninth aspect, alone or in combination with the eighth aspect, process 800 includes performing the beam down-selection procedure based at least in part on facilitating a selection of a subset of beams of a set of beams, wherein the subset of beams includes the selected beam.

In a tenth aspect, alone or in combination with the ninth aspect, facilitating the selection of the subset of beams comprises transmitting an additional beamformed reference signal to the plurality of UEs.

In an eleventh aspect, alone or in combination with one or more of the eighth through tenth aspects, process 800 includes performing the UE down-selection procedure based at least in part on selecting the plurality of UEs from among a larger plurality of UEs based at least in part on one or more performance measurements associated with the larger plurality of UEs.

In a twelfth aspect, alone or in combination with one or more of the eighth through eleventh aspects, process 800 includes transmitting a beam training procedure configuration that indicates the at least one phase.

In a thirteenth aspect, alone or in combination with the twelfth aspect, transmitting the beam training procedure comprises transmitting at least one of an RRC message or a MAC CE.

In a fourteenth aspect, alone or in combination with one or more of the twelfth through thirteenth aspects, process 800 includes transmitting an activation indication associated with the beam training procedure via at least one of an RRC message, a MAC CE, a DCI transmission, or an SCI transmission.

In a fifteenth aspect, alone or in combination with the fourteenth aspect, process 800 includes transmitting a gap timing that indicates an amount of time between a first event and a second event, wherein the first event comprises at least one of an activation or a first training phase, and the second event comprises a second training phase.

In a sixteenth aspect, alone or in combination with one or more of the first through fifteenth aspects, receiving the plurality of beamformed reference signals comprises receiving the plurality of beamformed reference signals via a sidelink connection.

In a seventeenth aspect, alone or in combination with one or more of the first through sixteenth aspects, process 800 includes determining the at least one measurement associated with the plurality of beamformed reference signals.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a relay UE, in accordance with the present disclosure. Example process 900 is an example where the relay UE (e.g., relay UE 610 and/or relay UE 615) performs operations associated with beam training for coordinated relaying.

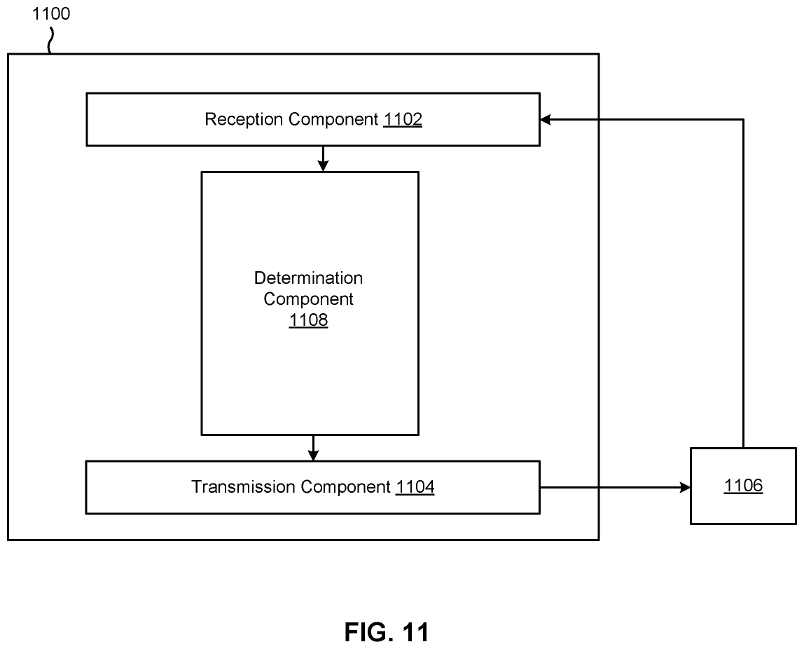

As shown in FIG. 9, in some aspects, process 900 may include transmitting, to a receiving UE, a beamformed reference signal of a plurality of beamformed reference signals associated with a set of time resources (block 910). For example, the relay UE (e.g., using transmission component 1104, depicted in FIG. 11) may transmit, to a receiving UE, a beamformed reference signal of a plurality of beamformed reference signals associated with a set of time resources, as described above.

As further shown in FIG. 9, in some aspects, process 900 may include receiving an indication of a reference signal index that indicates a selected beam based at least in part on a determination that at least one measurement associated with the plurality of beamformed reference signals satisfies one or more measurement criteria (block 920). For example, the relay UE (e.g., using reception component 1102, depicted in FIG. 11) may receive an indication of a reference signal index that indicates a selected beam based at least in part on a determination that at least one measurement associated with the plurality of beamformed reference signals satisfies one or more measurement criteria, as described above.

Process 900 may include additional aspects, such as any single aspect or any combination of aspects described below and/or in connection with one or more other processes described elsewhere herein.

In a first aspect, the at least one measurement comprises at least one of a standard parasitic exchange format measurement associated with a beamformed reference signal of the plurality of beamformed reference signals, an energy measurement associated with the beamformed reference signal of the plurality of beamformed reference signals, or a signal to interference plus noise ratio associated with the beamformed reference signal of the plurality of beamformed reference signals.

In a second aspect, alone or in combination with the first aspect, the reference signal index comprises at least one of a reference signal identifier corresponding to a set of reference signal resources, or a time index corresponding to a time resource of the set of time resources.

In a third aspect, alone or in combination with one or more of the first and second aspects, process 900 includes transmitting an instance of a communication of a plurality of instances of the communication to the receiving UE based at least in part on the reference signal index.

In a fourth aspect, alone or in combination with the third aspect, process 900 includes encoding the instance of the communication based at least in part on one or more precoders associated with the reference signal index.

In a fifth aspect, alone or in combination with one or more of the first through fourth aspects, process 900 includes receiving a training configuration from the receiving UE, wherein the training configuration indicates a quantity of time resources in the set of time resources.

In a sixth aspect, alone or in combination with the fifth aspect, receiving the training configuration comprises receiving an RRC message, a MAC CE, a DCI transmission, or an SCI transmission.

In a seventh aspect, alone or in combination with one or more of the first through sixth aspects, the selected beam corresponds to a selection of the selected beam based at least in part on a beam training procedure having at least one phase, wherein the at least one phase comprises at least one of a beam down-selection procedure or a UE down-selection procedure.

In an eighth aspect, alone or in combination with the seventh aspect, process 900 includes receiving an indication of a result of a beam down-selection procedure based at least in part on a selection of a subset of beams of a set of beams, wherein the subset of beams includes the selected beam.

In a ninth aspect, alone or in combination with one or more of the seventh through eighth aspects, the UE down-selection procedure is based at least in part on a selection of the plurality of UEs from among a larger plurality of UEs based at least in part on one or more performance measurements associated with the larger plurality of UEs.

In a tenth aspect, alone or in combination with one or more of the seventh through ninth aspects, process 900 includes receiving a beam training procedure configuration that indicates the at least one phase.

In an eleventh aspect, alone or in combination with the tenth aspect, receiving the beam training procedure comprises receiving at least one of an RRC message or a MAC CE.

In a twelfth aspect, alone or in combination with one or more of the first through eleventh aspects, process 900 includes receiving an activation indication associated with the beam training procedure via at least one of an RRC message, a MAC CE, a DCI transmission, or an SCI transmission.

In a thirteenth aspect, alone or in combination with one or more of the first through twelfth aspects, process 900 includes receiving a gap timing that indicates an amount of time between a first event and a second event, wherein the first event comprises at least one of an activation or a first training phase, and the second event comprises a second training phase.

In a fourteenth aspect, alone or in combination with one or more of the first through thirteenth aspects, transmitting the beamformed reference signals comprises transmitting the plurality of beamformed reference signals via a sidelink connection.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a receiving wireless communication device (e.g., a UE or a base station, among other examples), or a receiving wireless communication device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a determination component 1008.

In some aspects, the apparatus 1000 may be configured to perform one or more operations described herein in connection with FIGS. 6 and/or 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE and/or the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE and/or the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE and/or the base station described above in connection with FIG. 2. In some aspects, the transmission component 1004 may be co-located with the reception component 1002 in a transceiver.

The reception component 1002 may receive, from a plurality of relay UEs, a plurality of beamformed reference signals associated with a set of time resources for beam training for coordinated relaying. The transmission component 1004 may transmit an indication of a reference signal index that indicates a selected beam based at least in part on a determination that at least one measurement associated with the plurality of beamformed reference signals satisfies one or more measurement criteria.

The determination component 1008 may determine a training configuration, select a selected beam based on a training procedure, perform a beam down-selection procedure, perform a UE down-selection procedure, and/or determine one or measurements associated with beamformed reference signals, among other examples. In some aspects, the determination component 1008 may include one or more antennas, a modulator, a transmit MIMO processor, a transmit processor, a controller/processor, a memory, or a combination thereof, of the UE and/or the base station described above in connection with FIG. 2. In some aspects, the determination component 1008 may include the reception component 1002 and/or the transmission component 1004.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a relay UE, or a relay UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a determination component 1108.

In some aspects, the apparatus 1100 may be configured to perform one or more operations described herein in connection with FIGS. 6 and/or 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The transmission component 1104 may transmit, to a receiving UE, a beamformed reference signal of a plurality of beamformed reference signals associated with a set of time resources. The reception component 1102 may receive an indication of a reference signal index that indicates a selected beam based at least in part on a determination that at least one measurement associated with the plurality of beamformed reference signals satisfies one or more measurement criteria.

The determination component 1108 may process and implement beam training procedures, determine reference signal parameters, determine timing for transmitting reference signals, and/or perform any number of relaying functions, among other examples. In some aspects, the determination component 1108 may include one or more antennas, a modulator, a transmit MIMO processor, a transmit processor, a controller/processor, a memory, or a combination thereof, of the UE described above in connection with FIG. 2. In some aspects, the determination component 1108 may include the reception component 1102 and/or the transmission component 1104.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a receiving wireless communication device, comprising: receiving, from a plurality of relay user equipment (UEs), a plurality of beamformed reference signals associated with a set of time resources for beam training for coordinated relaying; and transmitting an indication of a reference signal index that indicates a selected beam based at least in part on a determination that at least one measurement associated with the plurality of beamformed reference signals satisfies one or more measurement criteria.

Aspect 2: The method of Aspect 1, wherein the at least one measurement comprises at least one of: a standard parasitic exchange format measurement associated with a beamformed reference signal of the plurality of beamformed reference signals, an energy measurement associated with the beamformed reference signal of the plurality of beamformed reference signals, or a signal to interference plus noise ratio associated with the beamformed reference signal of the plurality of beamformed reference signals.

Aspect 3: The method of either of Aspects 1 or 2, further comprising determining that at least one measurement associated with the plurality of beamformed reference signals satisfies one or more measurement criteria.

Aspect 4: The method of any of Aspects 1-3, wherein the reference signal index comprises at least one of: a reference signal identifier corresponding to a set of reference signal resources, or a time index corresponding to a time resource of the set of time resources.

Aspect 5: The method of any of Aspects 1-4, further comprising receiving a plurality of instances of a communication from the plurality of relay UEs based at least in part on the reference signal index.

Aspect 6: The method of Aspect 5, wherein the plurality of instances of the communication are encoded based at least in part on one or more precoders associated with the reference signal index.

Aspect 7: The method of any of Aspects 1-6, further comprising transmitting a training configuration to the plurality of relay UEs, wherein the training configuration indicates a quantity of time resources in the set of time resources.

Aspect 8: The method of Aspect 7, wherein transmitting the training configuration comprises transmitting a radio resource control message, a medium access control control element, a downlink control information transmission, or a sidelink control information transmission.

Aspect 9: The method of any of Aspects 1-8, further comprising selecting the selected beam based at least in part on a beam training procedure having at least one phase, wherein the at least one phase comprises at least one of a beam down-selection procedure or a UE down-selection procedure.

Aspect 10: The method of Aspect 9, further comprising performing the beam down-selection procedure based at least in part on facilitating a selection of a subset of beams of a set of beams, wherein the subset of beams includes the selected beam.

Aspect 11: The method of Aspect 10, wherein facilitating the selection of the subset of beams comprises transmitting an additional beamformed reference signal to the plurality of UEs.

Aspect 12: The method of any of Aspects 9-11, further comprising performing the UE down-selection procedure based at least in part on selecting the plurality of UEs from among a larger plurality of UEs based at least in part on one or more performance measurements associated with the larger plurality of UEs.

Aspect 13: The method of any of Aspects 9-12, further comprising transmitting a beam training procedure configuration that indicates the at least one phase.

Aspect 14: The method of Aspect 13, wherein transmitting the beam training procedure comprises transmitting at least one of a radio resource control message or a medium access control control element.

Aspect 15: The method of either of Aspects 13 or 14, further comprising transmitting an activation indication associated with the beam training procedure via at least one of: a radio resource control message, a medium access control control element, a downlink control information (DCI) transmission, or a sidelink control information (SCI) transmission.

Aspect 16: The method of Aspect 15, further comprising transmitting a gap timing that indicates an amount of time between a first event and a second event, wherein the first event comprises at least one of an activation or a first training phase, and wherein the second event comprises a second training phase.

Aspect 17: The method of any of Aspects 1-16, wherein receiving the plurality of beamformed reference signals comprises receiving the plurality of beamformed reference signals via a sidelink connection.

Aspect 18: The method of any of Aspects 1-17, further comprising determining the at least one measurement associated with the plurality of beamformed reference signals.

Aspect 19: A method of wireless communication performed by a relay user equipment (UE), comprising: transmitting, to a receiving UE, a beamformed reference signal of a plurality of beamformed reference signals associated with a set of time resources; and receiving an indication of a reference signal index that indicates a selected beam based at least in part on a determination that at least one measurement associated with the plurality of beamformed reference signals satisfies one or more measurement criteria.

Aspect 20: The method of Aspect 19, wherein the at least one measurement comprises at least one of: a standard parasitic exchange format measurement associated with a beamformed reference signal of the plurality of beamformed reference signals, an energy measurement associated with the beamformed reference signal of the plurality of beamformed reference signals, or a signal to interference plus noise ratio associated with the beamformed reference signal of the plurality of beamformed reference signals.

Aspect 21: The method of either of Aspects 19 or 20, wherein the reference signal index comprises at least one of: a reference signal identifier corresponding to a set of reference signal resources, or a time index corresponding to a time resource of the set of time resources.

Aspect 22: The method of any of Aspects 19-21, further comprising transmitting an instance of a communication of a plurality of instances of the communication to the receiving UE based at least in part on the reference signal index.

Aspect 23: The method of Aspect 22, further comprising encoding the instance of the communication based at least in part on one or more precoders associated with the reference signal index.

Aspect 24: The method of any of Aspects 19-23, further comprising receiving a training configuration from the receiving UE, wherein the training configuration indicates a quantity of time resources in the set of time resources.

Aspect 25: The method of Aspect 24, wherein receiving the training configuration comprises receiving a radio resource control message, a medium access control control element, a downlink control information transmission, or a sidelink control information transmission.

Aspect 26: The method of any of Aspects 19-25, wherein the selected beam corresponds to a selection of the selected beam based at least in part on a beam training procedure having at least one phase, wherein the at least one phase comprises at least one of a beam down-selection procedure or a UE down-selection procedure.

Aspect 27: The method of Aspect 26, further comprising receiving an indication of a result of a beam down-selection procedure based at least in part on a selection of a subset of beams of a set of beams, wherein the subset of beams includes the selected beam.

Aspect 28: The method of either of Aspects 26 or 27, wherein the UE down-selection procedure is based at least in part on a selection of a plurality of UEs from among a larger plurality of UEs based at least in part on one or more performance measurements associated with the larger plurality of UEs.

Aspect 29: The method of any of Aspects 26-28, further comprising receiving a beam training procedure configuration that indicates the at least one phase.

Aspect 30: The method of Aspect 29, wherein receiving the beam training procedure comprises receiving at least one of a radio resource control message or a medium access control control element.

Aspect 31: The method of any of Aspects 19-30, further comprising receiving an activation indication associated with the beam training procedure via at least one of: a radio resource control message, a medium access control control element, a downlink control information (DCI) transmission, or a sidelink control information (SCI) transmission.

Aspect 32: The method of any of Aspects 19-31, further comprising receiving a gap timing that indicates an amount of time between a first event and a second event, wherein the first event comprises at least one of an activation or a first training phase, and wherein the second event comprises a second training phase.

Aspect 33: The method of any of Aspects 19-32, wherein transmitting the beamformed reference signals comprises transmitting the plurality of beamformed reference signals via a sidelink connection.

Aspect 34: An apparatus for wireless communication at a device, comprising a processor; memory coupled with the processor; and instructions stored in the memory and executable by the processor to cause the apparatus to perform the method of one or more of Aspects 1-18.

Aspect 35: A device for wireless communication, comprising a memory and one or more processors coupled to the memory, the memory and the one or more processors configured to perform the method of one or more of Aspects 1-18.

Aspect 36: An apparatus for wireless communication, comprising at least one means for performing the method of one or more of Aspects 1-18.

Aspect 37: A non-transitory computer-readable medium storing code for wireless communication, the code comprising instructions executable by a processor to perform the method of one or more of Aspects 1-18.

Aspect 38: A non-transitory computer-readable medium storing a set of instructions for wireless communication, the set of instructions comprising one or more instructions that, when executed by one or more processors of a device, cause the device to perform the method of one or more of Aspects 1-18.

Aspect 39: An apparatus for wireless communication at a device, comprising a processor; memory coupled with the processor; and instructions stored in the memory and executable by the processor to cause the apparatus to perform the method of one or more of Aspects 19-33.

Aspect 40: A device for wireless communication, comprising a memory and one or more processors coupled to the memory, the memory and the one or more processors configured to perform the method of one or more of Aspects 19-33.

Aspect 41: An apparatus for wireless communication, comprising at least one means for performing the method of one or more of Aspects 19-33.

Aspect 42: A non-transitory computer-readable medium storing code for wireless communication, the code comprising instructions executable by a processor to perform the method of one or more of Aspects 19-33.

Aspect 43: A non-transitory computer-readable medium storing a set of instructions for wireless communication, the set of instructions comprising one or more instructions that, when executed by one or more processors of a device, cause the device to perform the method of one or more of Aspects 19-33.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A receiving wireless communication device for wireless communication, comprising:
a memory; and
one or more processors, coupled to the memory, configured to:
receive, from a plurality of relay user equipment (UEs), a plurality of beamformed reference signals associated with a set of time resources for beam training for coordinated relaying; and
transmit an indication of a reference signal index that indicates a selected beam based at least in part on a determination that at least one measurement associated with the plurality of beamformed reference signals satisfies one or more measurement criteria.

2. The receiving wireless communication device of claim 1, wherein the at least one measurement comprises at least one of:
a standard parasitic exchange format measurement associated with a beamformed reference signal of the plurality of beamformed reference signals,
an energy measurement associated with the beamformed reference signal of the plurality of beamformed reference signals, or
a signal to interference plus noise ratio associated with the beamformed reference signal of the plurality of beamformed reference signals.

3. The receiving wireless communication device of claim 1, wherein the one or more processors are further configured to determine that at least one measurement associated with the plurality of beamformed reference signals satisfies one or more measurement criteria.

4. The receiving wireless communication device of claim 1, wherein the reference signal index comprises at least one of:
a reference signal identifier corresponding to a set of reference signal resources, or
a time index corresponding to a time resource of the set of time resources.

5. The receiving wireless communication device of claim 1, wherein the one or more processors are further configured to receive a plurality of instances of a communication from the plurality of relay UEs based at least in part on the reference signal index.

6. The receiving wireless communication device of claim 5, wherein the plurality of instances of the communication are encoded based at least in part on one or more precoders associated with the reference signal index.

7. The receiving wireless communication device of claim 1, wherein the one or more processors are further configured to transmit a training configuration to the plurality of relay UEs, wherein the training configuration indicates a quantity of time resources in the set of time resources.

8. The receiving wireless communication device of claim 7, wherein the one or more processors, when transmitting the training configuration, are configured to transmit a radio resource control message, a medium access control control element, a downlink control information transmission, or a sidelink control information transmission.

9. The receiving wireless communication device of claim 1, wherein the one or more processors are further configured to select the selected beam based at least in part on a beam training procedure having at least one phase, wherein the at least one phase comprises at least one of a beam down-selection procedure or a UE down-selection procedure.

10. The receiving wireless communication device of claim 9, wherein the one or more processors are further configured to perform the beam down-selection procedure based at least in part on facilitating a selection of a subset of beams of a set of beams, wherein the subset of beams includes the selected beam.

11. The receiving wireless communication device of claim 10, wherein the one or more processors, when facilitating the selection of the subset of beams, are configured to transmit an additional beamformed reference signal to the plurality of relay UEs.

12. The receiving wireless communication device of claim 9, wherein the one or more processors are further configured to perform the UE down-selection procedure based at least in part on selecting the plurality of relay UEs from among a larger plurality of relay UEs based at least in part on one or more performance measurements associated with the larger plurality of relay UEs.

13. The receiving wireless communication device of claim 9, wherein the one or more processors are further configured to transmit a beam training procedure configuration that indicates the at least one phase.

14. The receiving wireless communication device of claim 13, wherein the one or more processors, when transmitting the beam training procedure, are configured to transmit at least one of a radio resource control message or a medium access control control element.

15. The receiving wireless communication device of claim 13, wherein the one or more processors are further configured to transmit an activation indication associated with the beam training procedure via at least one of:
a radio resource control message,
a medium access control control element,
a downlink control information (DCI) transmission, or
a sidelink control information (SCI) transmission.

16. The receiving wireless communication device of claim 15, wherein the one or more processors are further configured to transmit a gap timing that indicates an amount of time between a first event and a second event, wherein the first event comprises at least one of an activation or a first training phase, and wherein the second event comprises a second training phase.

17. The receiving wireless communication device of claim 1, wherein the one or more processors, when receiving the plurality of beamformed reference signals, are configured to receive the plurality of beamformed reference signals via a sidelink connection.

18. A relay user equipment (UE) for wireless communication, comprising:
a memory; and
one or more processors, coupled to the memory, configured to:
transmit, to a receiving UE, a beamformed reference signal of a plurality of beamformed reference signals associated with a set of time resources; and
receive an indication of a reference signal index that indicates a selected beam based at least in part on a determination that at least one measurement associated with the plurality of beamformed reference signals satisfies one or more measurement criteria.

19. The relay UE of claim 18, wherein the at least one measurement comprises at least one of:
a standard parasitic exchange format measurement associated with a beamformed reference signal of the plurality of beamformed reference signals,
an energy measurement associated with the beamformed reference signal of the plurality of beamformed reference signals, or
a signal to interference plus noise ratio associated with the beamformed reference signal of the plurality of beamformed reference signals.

20. The relay UE of claim 18, wherein the reference signal index comprises at least one of:
a reference signal identifier corresponding to a set of reference signal resources, or
a time index corresponding to a time resource of the set of time resources.

21. The relay UE of claim 18, wherein the one or more processors are further configured to transmit an instance of a communication of a plurality of instances of the communication to the receiving UE based at least in part on the reference signal index.

22. The relay UE of claim 21, wherein the one or more processors are further configured to encode the instance of the communication based at least in part on one or more precoders associated with the reference signal index.

23. The relay UE of claim 18, wherein the one or more processors are further configured to receive a training configuration from the receiving UE, wherein the training configuration indicates a quantity of time resources in the set of time resources.

24. The relay UE of claim 18, wherein the selected beam corresponds to a selection of the selected beam based at least in part on a beam training procedure having at least one phase, wherein the at least one phase comprises at least one of a beam down-selection procedure or a UE down-selection procedure.

25. The relay UE of claim 24, wherein the one or more processors are further configured to receive an indication of a result of a beam down-selection procedure based at least in part on a selection of a subset of beams of a set of beams, wherein the subset of beams includes the selected beam.

26. The relay UE of claim 24, wherein the UE down-selection procedure is based at least in part on a selection of a plurality of relay UEs from among a larger plurality of relay UEs based at least in part on one or more performance measurements associated with the larger plurality of relay UEs.

27. A method of wireless communication performed by a receiving wireless communication device, comprising:
receiving, from a plurality of relay user equipment (UEs), a plurality of beamformed reference signals associated with a set of time resources for beam training for coordinated relaying; and
transmitting an indication of a reference signal index that indicates a selected beam based at least in part on a determination that at least one measurement associated with the plurality of beamformed reference signals satisfies one or more measurement criteria.

28. The method of claim 27, further comprising receiving a plurality of instances of a communication from the plurality of relay UEs based at least in part on the reference signal index.

29. A method of wireless communication performed by a relay user equipment (UE), comprising:
transmitting, to a receiving UE, a beamformed reference signal of a plurality of beamformed reference signals associated with a set of time resources; and
receiving an indication of a reference signal index that indicates a selected beam based at least in part on a determination that at least one measurement associated with the plurality of beamformed reference signals satisfies one or more measurement criteria.

30. The method of claim 29, further comprising transmitting an instance of a communication of a plurality of instances of the communication to the receiving UE based at least in part on the reference signal index.
